(19) United States
(12) Patent Application Publication
(10) Pub. No.: US 2010/0255908 A1
(43) Pub. Date: Oct. 7, 2010

(54) MULTIMEDIA-ENABLED PHYSICAL TRADING CARD

(76) Inventor: Stephen Michael Grimes, Berkeley Heights, NJ (US)

Correspondence Address: Kane Kessler P.C., 1350 Avenue of the Americas, 26th Floor, New York, NY, 10019, US

(21) Appl. No.: 12/697,131

(22) Filed: Jan. 29, 2010

Related U.S. Application Data
(60) Provisional application No. 61/206,443, filed on Jan. 29, 2009.

(51) Int. Cl. A63F 13/00; A63F 13/12

(52) U.S. Cl. 463/31; 463/43; 463/42

(57) ABSTRACT

A trading card containing embedded memory coupled to a computer interface for connecting the embedded memory to a computer. The memory device may contain multimedia content that may be accessed through the computer, electronic trading cards, or enable content to be retrieved from a separate location accessed by the computer.

### CROSS REFERENCE TO RELATED APPLICATION

This application claims the benefit of U.S. Provisional Application 61/206,443, filed on Jan. 29, 2009, which is hereby incorporated by reference in its entirety.

### FIELD OF THE INVENTION

The present invention relates to a trading card incorporating a memory device and a computer interface. The memory within the trading card can be connected to a computer to access multimedia content or electronic trading cards associated with the sports or entertainment figure on the trading card.

More specifically, a typical trading card has a front side depicting a sports or entertainment figure and a back side having facts, statistics or other information relating to the sports or entertainment figure. The trading card typically has the same dimensions as any other trading card, but contains an embedded memory device connected to a computer interface, such as a USB port, so that the memory device may be connected to a computer. The memory device may contain multimedia content that may be accessed through the computer, may contain electronic trading cards, or may contain a unique access key or program that may enable multimedia content to be retrieved from a separate location to be accessed on the computer.

### BACKGROUND OF THE INVENTION

Sports and entertainment trading cards have been around for many years. Trading cards typically contain a picture of a popular sports figure, entertainment figure or famous place or event, along with a collection of personal information, statistics and/or interesting facts. Premium trading cards have been developed that include high quality lithography, printing on glossy cardboard stock with crisp color photographs on the front and/or back, various matted finishes and other combinations. Trading cards can be produced and collected for almost any type of interest, including, for example, sports such as baseball, football, hockey and soccer, as well as for television and movie actors or characters, games, science fiction and fantasy genres. Some trading cards become very valuable based on various factors including the authenticity and scarcity of the particular trading card. Over the years, various modifications to trading cards have been made to increase the collectible value of the cards. For instance, trading cards have been created which include the signature of the person depicted or which contain pieces of memorabilia that are associated with the person or event on the trading card. Trading cards also typically include certifications that the signature is authentic, or that the material included in the trading card is authentic and/or was used or worn during a particular event or by a particular person. Some trading cards include holographic marks and a serial numbers to prevent counterfeiting.

Many of the trading cards are designed to be part of a collectible group. For instance, a set of trading cards can consist of all of the characters of Star Wars or all of the players on a baseball team during a particular year. Thus, there is an incentive to collect all of the cards within a set. However, trading cards are typically grouped in packets and sold as a single package. The cards within the package are, for the most part, selected near randomly by the publisher of the trading cards so that valuable trading cards are interspersed among less valuable trading cards. Moreover, the contents of the package are not ascertainable before purchase. To collect all of the characters in a set of trading cards, multiple packages must be purchased and/or the cards sought must be traded for or purchased in the secondary market. Often, trading card packs are sold where there is a specific chance of finding a valuable trading card within a single package. Such valuable trading cards are sometimes referred to as “chase cards” because collectors specifically seek such cards and may purchase the packs of cards specifically to obtain such cards. The excitement of potentially finding a valuable card within a package adds to the excitement of the purchase, and adds to the overall experience of collecting trading cards.

Recently, a greater interest has developed in combining the excitement of collecting trading cards with the online experience of the Internet. As an example, there is a greater interest in electronic trading cards, which are in essence a digital form of a physical trading card. The electronic trading card may appear as the same shape and size of a physical trading card, but is completely in electronic form. These electronic trading cards may be obtained by purchasing packs of physical trading cards which may contain a filler card with an access code, and entering the access code at an appropriate on-line website. Electronic trading cards may be traded back and forth with other collectors, generally through the Internet. Generally, electronic trading cards retain the excitement of the collecting and trading of physical trading cards if the electronic cards maintain scarcity and authenticity. Another aspect of the Internet is the ability to obtain pictures, video and other multimedia relating to sports and entertainment. Many of these types of multimedia content are freely available on the internet and are shared through many different websites. This type of information also enhances the experiences of the fans of the particular sports or entertainment figure.

It is in light of the foregoing that the current invention is contemplated.

### BRIEF DESCRIPTION OF THE DRAWINGS

The foregoing objects, aspects and advantages will be better understood from the following detailed description of the invention with respect to the drawings, in which:

FIGS. 1A and 1B are the front and back sides of a multimedia-enabled trading card;

FIG. 2 is a multimedia-enabled trading card with a USB adaptor in the extended position;

FIG. 3 is an exploded perspective view of a multimedia-enabled trading card;

FIG. 4 is another embodiment of a multimedia-enabled trading card;

FIG. 5 is yet another embodiment of a multimedia-enabled trading card;

FIG. 6 is system diagram of a network within which the invention can be implemented;

FIG. 7 shows a structural network device that may be used in the system for implementing the invention; and

FIG. 8 is a flow diagram for enabling multimedia content to be provided to the holder of the multimedia-enabled trading card.

### DETAILED DESCRIPTION OF THE INVENTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In one embodiment of the invention, the trading card contains a front surface depicting a sports or entertainment figure, a back surface containing statistics, facts or figures and an embedded memory device. The trading card contains an adaptor so that the memory device may interface with a computer. The memory device may contain multimedia content relating to the player on the card, an access code or a program that enables access to multimedia content, electronic trading cards or similar electronic information to be accessed by the user through the computer interfacing with the adapter.

In one embodiment of the system, the trading card contains a USB adaptor wherein in one position the trading card substantially contains the same look and characteristics of a trading card while in a second position of the adaptor, the adaptor may be physically connected to a computer through a USB port. In another embodiment of the system, the interface between the trading card and the computer is a wireless connection such that the trading card contains substantially the same look and characteristics of a trading card.

In yet other embodiment, the memory device on the trading card contains an encrypted access code that enables authentication of the trading card through a central server to, for example, determine that the trading card is one of a unique set of trading cards.

### Multimedia-Enabled Trading Card

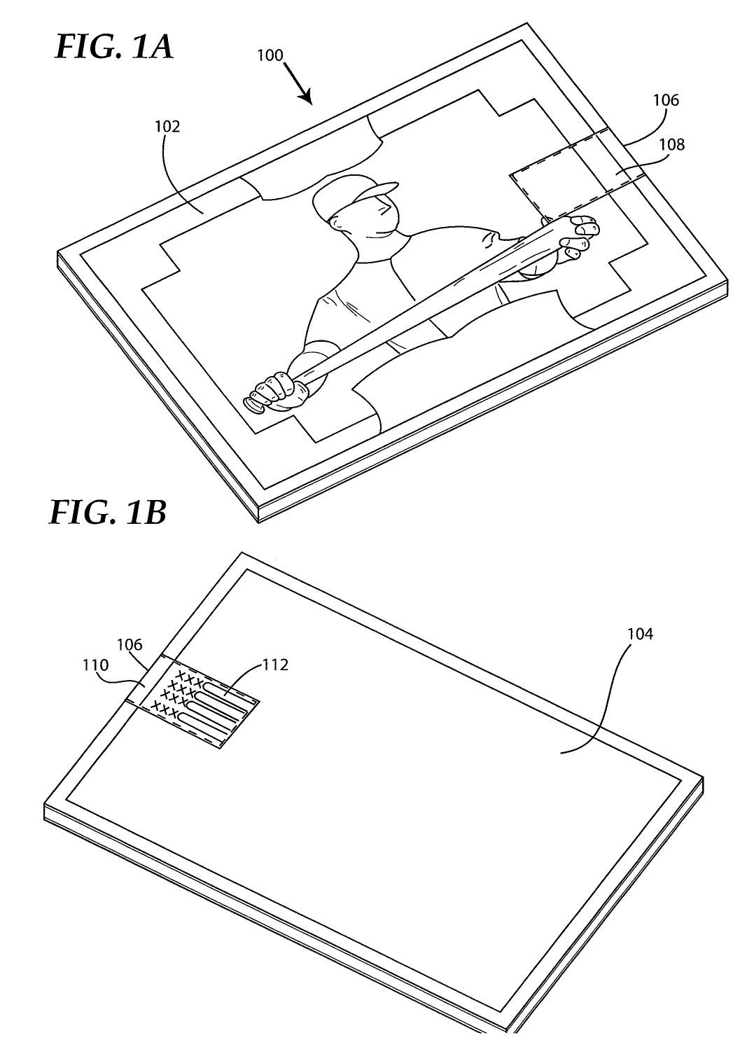

A multimedia-enabled trading card is depicted in FIGS. 1A and 1B. Multimedia-enabled trading card 100 is comprised of a front side 102 that typically contains an image of a sports or entertainment figure, or famous event or location. The backside of the card 104 may contain such things as statistics, descriptions or the like relating to the image on front side 102 of card 100. The multimedia-enabled trading card may have adaptor 106 that is integrally formed with the trading card. Adaptor 106 is formed such that adaptor top surface 108 forms part of the image on front surface 102 and adaptor back surface 110 forms part of the image on back surface 104. Adapter back surface 110 may contain adapter contacts 112 for providing an electrical interface with a computer. Adaptor top surface 108 and adaptor back surface 110 may be flush with the front and back surfaces of the card, respectively, so that the trading card maintains the same relative dimensions as a typical trading card.

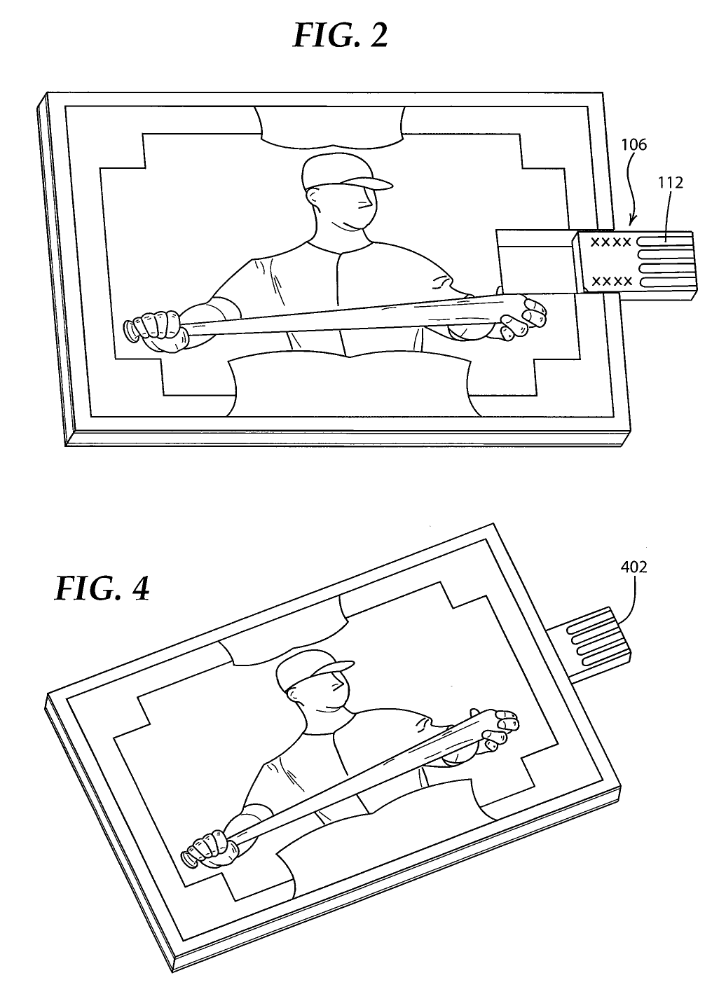

Adaptor 106 may be rotated 180 degrees around a pivot point to expose adapter contacts 112. In this embodiment, the adaptor is a universal serial bus (USB) interface. Adapter contacts 112 are connected to a memory device within the multimedia-enabled trading card. In FIG. 2, adaptor 106 is in the extended position and is configured to interface with a standard USB port on a computer.

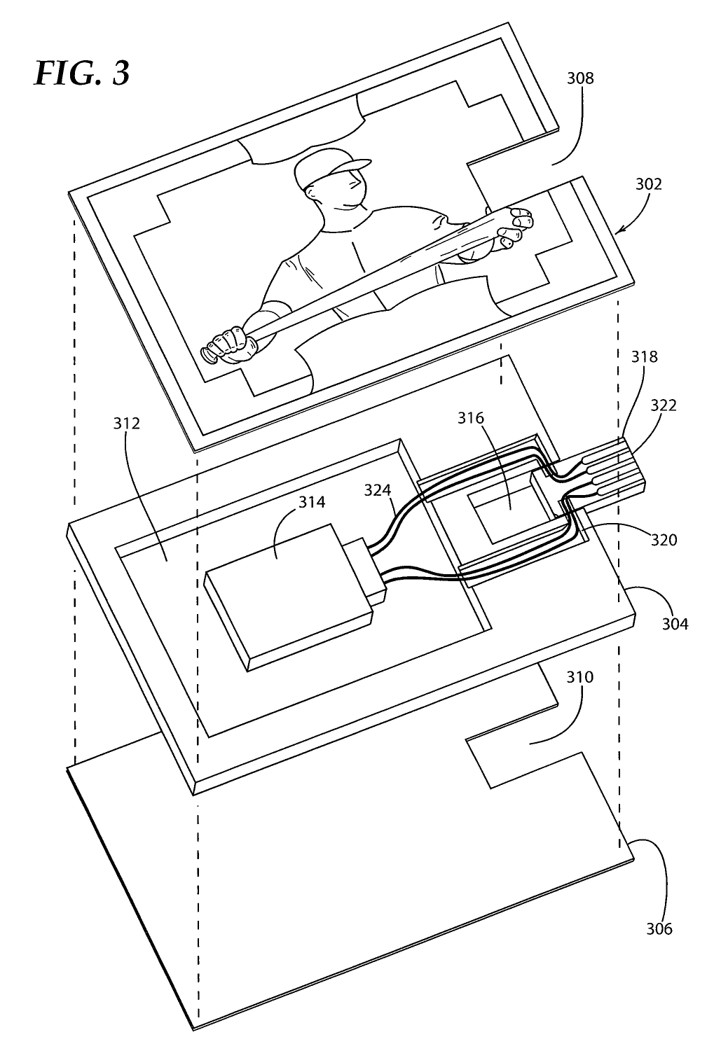

An exploded perspective view of the multimedia-enabled trading card is shown in FIG. 3. In one embodiment, the trading card consists of top layer 302, spacer layer 304 and bottom layer 306. Top layer 302 contains cutout 308 and bottom layer 306 contains cutout 310. Spacer layer 304 contains cutout section 312 for containing memory device 314. Memory device 314 may have a thickness that is the same as or smaller than the thickness of spacer layer 304 so that the trading card maintains the typical dimensions of a trading card. Spacer layer 304 has a second cutout section 316 that corresponds to cutout sections 308 and 310. Within cutout section 316 is adaptor 318. Adaptor 318 may be connected to spacer layer 304 through pins 320 disposed on each side of adaptor 318. Adaptor 318 may be rotated from a closed position wherein the dimensions of the trading card are maintained to an open position wherein the adaptor may be inserted into a USB port of a computer. Memory device 314 is connected to contacts 322 through wires 324. Adaptor 318 may be capable of being rotated only 180 degrees from a closed position to an open position or may be rotatable 360 degrees, for instance through use of slip rings between electrical wires 324 and contacts 322 on pin 320.

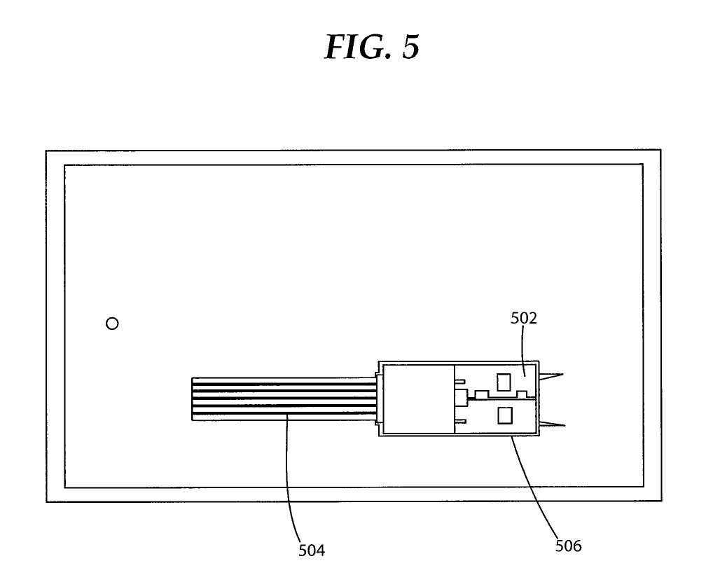

FIGS. 4 and 5 show two alternative embodiments for the multimedia trading cards. In FIG. 4, adaptor 402 is configured to slide in and out of the trading card along its edge. The movement may be assisted through an internal spring, biasing element or the like, and have an actuatable mechanism for keeping the adapter either in the closed or open position. In FIG. 5, adaptor 502 is connected to the trading card through wires 504. Connector 502 and wires 504 may be placed within recess 506. In an alternative embodiment, there may be a removable piece to cover recess 506 so that the trading card has the same appearance as any other trading card.

In yet another embodiment of the multimedia-enabled trading card, the card may be blue-tooth enabled, may contain an infrared communication port or other type of wireless communication with a computer. The advantage to using a USB adaptor is that power to the memory device is provided through the USB port. However, power may be provided to a wireless multimedia-enabled trading card by providing a solar cell as an integral part of one of the surfaces of the card or by providing or supplying external power through a non-contact method. Non-contact energy transfer systems are used in various fields and can be made integral to the multimedia-enabled trading card. As another alternative, power supply contacts may be placed inconspicuously on the surface of the trading card and the memory device may be connected to a rechargeable power supply embedded within the trading card.

### Environment for Implementing the Invention

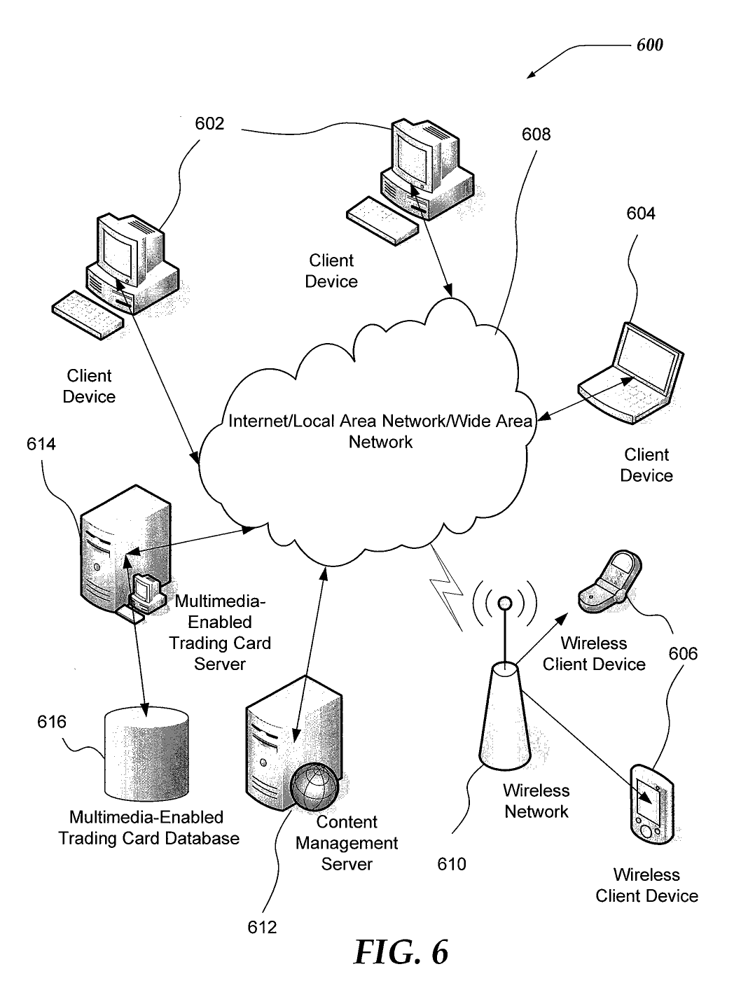

Network 600 is shown in FIG. 6. Not all of the components are required for any given implementation of the invention, and variations in the arrangement and types of components may be made without departing from the scope of the invention. As shown in FIG. 6, client devices 602, 604 can consist of personal computers, laptop computers and any other device capable of establishing a communication link with Internet/Local Area Network/Wide Area Network 608 through a wired communications medium. Client devices 602, 604 may be linked to other Wide Area Networks and/or Local Area Networks. Client devices may also consist of wireless client devices 606 such as cell phones, personal digital assistants, laptop computers, hand held computers and similar devices. Wireless client devices 606 are connected to Internet/Local Area Network/Wide Area Network 608 through wireless network 610. The client devices are capable of identifying their location to other devices within the various networks. For example, cellular phones can identify themselves through Mobile Identification Numbers, Electronic Serial Numbers or mobile phone numbers. Computer devices can identify themselves through network addresses or other device identifiers. The identifier information may be included in messages or information sent to other devices within the various networks so that communications can take place through the network between the devices. Such communication can take place through known communication methods such as Short Messaging Service (SMS), Multimedia Message Service (MMS), Instant Messaging (IM), Internet Relay Chat (IRC), Jabber or the like. Any suitable protocol or method of communication can be used to implement the current invention.

The client devices may include application programs that send and receive web-pages, web-based messages, data, packets having content for updating graphics on a client device and the like. The application programs may be browsers and associated programs that send, receive and display graphics, text, sound and multimedia. The client devices may have operating systems that enable the application programs, and use various protocols/languages to enable the web-based application programs such as Handheld Device Markup Language (HDML), HyperText Markup Language (HTML), JavaScript, extensible Markup Language (XML), and the like.

The various networks may also include network devices that provide content to users such as content management server 612. These devices are capable of sending and receiving text, photographs, web pages, multimedia information, and the like. These network devices provide substance of interest to users of Internet/Local Area Network/Wide Area Network 608.

Internet/local area server/wide area server 608 can couple Multimedia-Enabled Trading Card (“METC”) Server 614 to other computing devices including client devices 602, 604, wireless client devices 606 and Content Management Server 612. METC Server 614 can be configured to provide multimedia content, updated multimedia content or simply access or authentication verification to users of client devices 602, 604 and 606. METC Server 614 can draw content from Content Management Server 612 in implementing this invention. Internet/local area server/wide area server 608 can use any form of computer readable media for communicating with the various electronic devices. The connections between the electronic devices can be through twisted pair, coax, fiber optics, satellite, carrier waves or any other commonly known medium. The communications can take place through routers and other networking equipment in a conventional manner. Further, the communications can have dynamic architectures and use any of a number of known protocols for communication. However, such communications differ from the inventive message handling within a virtual environment as described further below.

METC Server 614 may include any type of computing device capable of networking with Internet/Local Area Network/Wide Area Network 608. In one embodiment, METC Server is connected with METC Database which stores data used by or received from users of the METC Server. In another embodiment, the data storage takes place within METC Server 614.

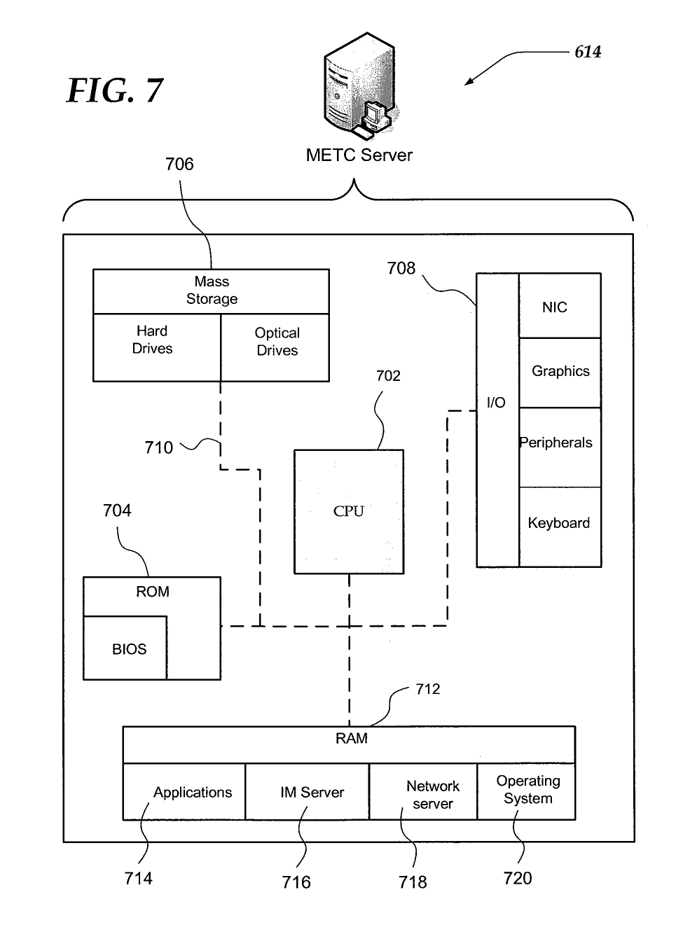

FIG. 7 shows one embodiment of a network device that can be used as METC Server 614. The network device includes central processing unit 702, input/output interface 708, ROM 704, RAM 712 and mass storage device 706. The various components are interconnected by bus 710. ROM 704 may include a Basic Input/Output System (BIOS) for controlling the low level operation of the network device. Ram 712 can contain various operating programs such as applications 714, Instant Message server 716, network server application 718 and operating system 720. Applications 714 can include the programs for implementing the current invention. For example, the applications in conjunction with network server 718 can receive the access code or METC verification information sent by users, and verify or authenticate the status of the METC.

The network device of FIG. 7 may also contain mass storage 706 which can be hard drives, optical drives, memory chips or similar devices for storing large quantities of data in non-volatile memory. Mass storage 706 may also store other program code and data. One or more applications 714 may be stored in mass storage 706 and then run within the environment of operating system 720.

The network device communicates through Input/Output device 708. Input/Output device 708 can constitute a number of separate devices. For instance, it may contain a network interface card, graphics card, peripheral controllers and the like. The server may also have a monitor and keyboard. The network device can communicate with a network, such as Internet/Local Area Network/Wide Area Network 608, through a network interface card using various communication protocols including TCP/IP protocol.

The invention can be implemented in several different ways. For example, the invention can be implemented through a traditional client server arrangement or a peer to peer network architecture. The application program can be implemented in client devices, network devices or any combination of various devices.

### General Operation

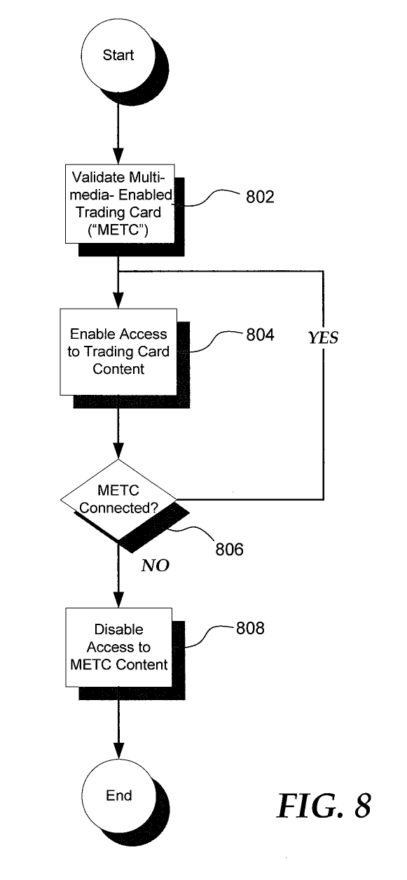

The general operation of one embodiment of the invention will be described with respect to FIG. 8. In one embodiment of the system, a user of the multimedia-enabled trading card will connect the trading card with the computer, for instance through a USB adaptor. In the Windows environment, when a device is plugged into the computer, automatic execution of certain files within a device may take place. USB was designed to allow many peripherals to be connected using a single standardized interface socket and to improve the plug-and-play capabilities by allowing hot swapping, that is, by allowing devices to be connected and disconnected without rebooting the computer or turning off the device. Other convenient features include providing power to low-consumption devices without the need for an external power supply and allowing many devices to be used without requiring manufacturer specific, individual device drivers to be installed.

In this particular instance, the device may be configured to automatically start a program that provides multimedia content, games or other content that is related to the trading card. The content may contain additional information about the player. It may contain videos of performances of the person or conversations with the person. The videos or pictures of the person may be of the person out of uniform, an interview with the person, how-to videos (such as how to hit a slider) or other content that either is not readily available or not available in an aggregated form. As an alternative, the METC card may unlock an electronic trading card such as a replica of the current trading card that may exist and be accessed only by the person that has the METC. Alternatively, the unlocked electronic trading card may have an independent existence from the METC once unlocked, or the program run in association with the METC may provide the ability to provide the electronic trading card with an independent existence on satisfying certain conditions, such as inputting a code or series of codes. Those codes or series of codes may be distributed through trading cards, on-line, through execution of game play or similar promotional events. As another alternative embodiment, the multimedia-enabled trading card may unlock additional surprise players or other electronic trading cards.

In yet another embodiment, after the multimedia-enabled trading card is connected to the computer, a server may be accessed, such as METC server 614. The access with the server may cause updated content to be written to the memory of the multimedia-enabled trading card. Alternatively, the server may cause a program to be executed, or downloaded and/or executed, that permits access to the content on the METC. In another embodiment, the multimedia-enabled trading card may contain an access code or encrypted information that identifies the multimedia-enabled trading card to the METC server. In such an instance, the multimedia trading card server may then provide the content, updated content, or access to content already on the METC to the computer to which the multimedia-enabled trading card is connected.

In another embodiment of the system, the scarcity and authenticity of the multimedia-enabled trading card is maintained by ensuring that the content of memory 314 cannot be easily reproduced onto other memory devices. This may be accomplished by known encryption and anti-privacy techniques. The scarcity and authenticity may also be maintained by requiring registration of ownership and/or transfer of ownership with the server, or by verification with records contained on or associated with the server.

The flow process for one example of the invention is shown in FIG. 8. The process is started when the multimedia-enabled trading card is interfaced with a networked computer. For example, adapter 106 of METC 100 is placed in the extended position and inserted into a USB port of a computer with Internet access capability. In block 802, the multimedia-enabled trading card is validated as being authentic. The validation may occur by transmitting an access code or authentication information contained in the memory of the METC to a centralized server. The centralized server may compare the code or information against a stored database of such information, and may require additional information such as the current registration information for such multimedia trading card. As one example, on first use of the trading card, the user may be prompted for registration information such as name, address, a username, password or other similar information. Thereafter, to access the information, the user must connect the trading card to the computer and then enter in verification information such as their username and access code. This would reduce piracy of trading cards and/or electronic information. In essence, the validation techniques make sure that the multimedia-enabled trading card is authentic and unique.

After validation of the multimedia-enabled trading card, the system may enable access to trading card content as shown in block 804. This access may be through a program contained within the electronic trading card or through a program either run from or downloaded from a centralized server which would then present, for example, multimedia content to the user relating to the trading card player or entertainment personality depicted on the trading card. Alternatively, access may be enabled to an electronic trading card corresponding to the sports figure or entertainment figure depicted on the card. In yet another embodiment, the multimedia content may be contained in and run from the memory on the local computer through a program and such content updated through access with the centralized server.

In one embodiment of this system, the multimedia content may only be provided while the multimedia-enabled trading card is connected to the client computer. This is shown in decision block 806 wherein access is enabled to the content only while the multimedia-enabled trading card is connected to the client computer. When the multimedia trading card is disconnected from the computer, access is disabled to the trading card content as shown in block 808.

Because the dimensions of the multimedia-enabled trading card are similar to other trading cards, such as relic or autograph cards, the multimedia-enabled trading cards may be chase cards and sold in blind purchase packages. This would provide the additional thrill and excitement to trading card collectors of finding a valuable trading card and the additional excitement of viewing multimedia content or electronic trading cards related to the trading card.

In yet another embodiment of the invention, the memory within the trading card may contain statistics for the player depicted on the card. Through the same process of validation and/or enabling access to trading card content, the statistics for the particular player on the card may be updated each time the card is connected to the computer. This would provide a centralized resource for a fan to follow a particular player or entertainment figure. Moreover, the information on the playing card may be tailored by the user such that the user may obtain certain types of information or may control the layout of such information with respect to the player, team or entertainment personality depicted on the card.

As an example, the multimedia-enabled trading card may depict Alex Rodriguez. When connected to a networked client device, the user may gain access to an Alex Rodriguez electronic trading card, statistics and information about Alex Rodriguez that may be updated each time that the multimedia-enabled trading card is connected to the networked client device, and may view interviews showing Alex Rodriguez teaching how to hit a slider and clips of game highlights of Alex Rodriguez playing baseball. In addition, the user may tailor the display to show only relevant information such as only batting history or any other type of information that the user is interested in.

In yet another embodiment of the system, instead of containing memory 314, the trading card may contain a microprocessor, associated memory and related circuitry. The microprocessor may execute many of the above-described functions. An advantage of this embodiment is that the ability to copy or reproduce information in the memory would be limited to a great extent. In yet another embodiment, the memory or microprocessor imbedded within the trading card may be used to drive a display device that takes place of, for instance, the statistics located on the back side of the trading card. The statistics may be displayed continuously using low-power consumption techniques, with re-charging of the power source occurring through the USB port or other known ways. The statistics may be updated each time that the trading card is connected to a networked computing device, whether through a physical connection or through a wireless-type of connection.

1. A collectible trading card comprising:
a front card formed from cardstock with an image of a famous figure, location, or event;
a back card formed from cardstock;
a spacer frame having a cutout section and attached to and located between the front and back cards;
a memory device located within the cutout of the spacer frame and between the front and back cards;
an adaptor electrically coupled to the memory device that allows connection of the memory device to a computing device; and
the memory device containing computer readable program code adapted for enabling access to content relating to the famous figure, location or event.

2. The collectible trading card of claim 1, further comprising:
the adaptor being pivotally connected to the spacer frame where:
in a first closed position, the adaptor is within an area defined by planes of a top surface of the front card, a bottom surface of the back card and all peripheral edges of the front and back cards; and
in a second open position, the adaptor extends beyond at least one of the planes of the top surface, bottom surface or side edges of the front and back cards.

3. The collectible trading card of claim 1 where in the adaptor is slideably connected to the spacer frame.

4. The collectible trading card of claim 1, wherein the content relating to the famous figure, location or event is a multimedia program or statistical information.

5. The collectible trading card of claim 1, further comprising:
a microprocessor located within the cutout of the spacer frame and between the front and back ends and further being coupled to the memory and adaptor; and
the microprocessor configured to interface with a computer automatically executes the computer readable program code to enable access to the content.

6. The collectible trading card of claim 1, wherein the program automatically executes when the adaptor is connected to a computer to display the content.

7. The collectible trading card of claim 1, further comprising:
a networked computer connected to the memory device through the adaptor.

8. The collectible trading card of claim 7, wherein the computer readable program code is adapted to be executed to cause the networked computer to initiate a connection with a remote server and download the content.

9. The collectible trading card of claim 1, wherein the computer readable program code is adapted to be executed to display content contained on the memory device.

10. A collectible trading card comprising:
a front surface with an image of a famous figure, location or event;
a back surface with information relating to the image;
a computer usable medium enclosed between the front and back surfaces;
an interface coupled to the computer usable medium and capable of coupling to a computer; and
the computer usable medium having a computer readable program code adapted to be executed by the computer to implement a method for providing interactive content, the method comprising:
initiating connection from the computer to a remote server through a network;
transmitting access information to the remoter server to verify authority to access image related information; and
providing access to the image related information only while computer usable medium is coupled to the computer through the interface.

11. The collectible trading card of claim 10, further comprising:
an electronic display integrated with the back surface.

12. The collectible trading card of claim 11, further comprising:
the computer usable medium having the computer readable program code adapted to be executed by the computer to implement the method for providing content, the method further comprising:
receiving statistical information relating to the image; and
displaying the statistical information on the electronic display.

13. The collectible trading card of claim 10, further comprising:
the computer usable medium having the computer readable program code adapted to be executed by the computer to implement the method for providing content, the method further comprising:
providing access to image related information consisting of an electronic version of the collectible trading card; and
permitting modification of ownership rights to the electronic version of the collectible trading card.

14. The collectible trading card of claim 10, wherein the image related information is a multimedia program, statistical information or an electronic version of the collectible trading card.

15. The collectible trading card of claim 10, wherein the interface is wireless.

16. A collectible trading card comprising:
a front surface with an image of a famous figure, location or event;
a back surface with information relating to the image;
a computer usable medium enclosed between the front and back surfaces;
an interface coupled to the computer usable medium and capable of coupling to a computer; and
the computer usable medium having a computer readable program code adapted to be used by the computer to implement a method for providing content, the method comprising:
executing an application program on the computer to display multimedia programming relating to the famous figure, location or event; and
disabling access to the multimedia content on detecting removal of the interface from the computer.

17. The collectible trading card of claim 16, wherein the multimedia content is located on a remote server.

18. The collectible trading card of claim 16, wherein the multimedia content is located on the computer usable medium.

19. The collectible trading card of claim 16, wherein the computer readable program code enables automatic execution when the computer usable medium is coupled to the computer.

20. The collectible trading card of claim 16 further comprising:
two or more traditional trading cards; and
a package enclosing the collectible trading card and two or more traditional trading cards, wherein the identity of the trading cards cannot be determined prior to opening the package.
